(19) United States
(12) Patent Application Publication
(10) Pub. No.: US 2009/0048897 A1
(43) Pub. Date: Feb. 19, 2009

(54) COLLECTIONS PROCESSING SYSTEMS

(75) Inventors: Debabrat Parikshya, Chennai (IN); Krishna Ramkrishnan, Chennai (IN)

Correspondence Address: BANNER & WITCOFF, LTD.;ATTORNEYS FOR CLIENT NO. 005222, 10 S. WACKER DRIVE, 30TH FLOOR, CHICAGO, IL, 60606, US

(73) Assignee: Accenture Global Services GmbH, Schaffhausen (CH)

(21) Appl. No.: 11/937,178

(22) Filed: Nov. 8, 2007

(30) Foreign Application Priority Data
Aug. 13, 2007 (IN) 1570/MUM/2007

(51) Int. Cl. G06Q 10/00; G06F 17/40; G06F 19/00

(52) U.S. Cl. 705/9

(57) ABSTRACT

Methods and systems for assigning work to account collectors and monitoring and tracking work performed by account collectors are provided. Files containing account information are parsed by a computer device to extract account data. A computer device then accesses a set of rules that govern assignments and priorities and processes the account information with the set of rules. The account information is then placed into a database with account collector assignments and priorities determined by the rules. Accountant collectors also provide status updates so that a variety of real time reports can be generated.

### FIELD OF THE INVENTION

This invention relates generally to systems used by account collecting enterprises. More particularly, aspects of the invention provide methods and systems for assigning work to account collectors and monitoring and tracking work performed by account collectors.

### DESCRIPTION OF RELATED ART

Account collecting enterprises typically assign accounts to a number of account collectors. Account collectors typically contact customers who are late on account payments and try to obtain payment. Contact is typically made via telephone or mail. It is common for team leaders to somewhat randomly assign accounts to account collectors. For example, a first account collector may be assigned the first 100 accounts, a second account collector may be assigned the next 100 accounts and so on.

With existing systems it is difficult for team leaders to effectively manage account collectors and implement priorities. For example, with manual assignment methods it is common to assign groups of accounts to account collectors to ensure that every account is assigned. This is even the case when a team leader recognizes that account collectors are each proficient at collecting on different types of accounts. For example, one account collector may be particularly proficient at collecting on old accounts and another account collector may be proficient at collecting on new accounts.

Existing systems also have limited reporting capabilities. As a result, it can be difficult for team leaders to effectively manage account collectors and perform functions such as obtaining real time data, monitoring individual account collectors and generating reports that display data with a wide range of granularity.

Therefore, there is a need in the art for systems and methods for assigning work to account collectors and monitoring and tracking work performed by account collectors.

### BRIEF SUMMARY OF THE INVENTION

Aspects of the invention overcome problems and limitations of the prior art by providing systems and methods that facilitate assigning work to account collectors and monitoring and tracking work performed by account collectors. A web based computer system is configured to extract account data from one or more files and assist a supervisor in assigning accounts to account collectors and tracking work. Supervisors are provided with computer based tools for reassigning and monitoring work. Account collectors provide status updates via a graphical user interface. Updates allow for the generation of a variety of real time reports.

Some embodiments of the invention may include or utilize computer-executable instructions for performing one or more of the disclosed methods. The computer-executable instructions may be stored on a tangible computer-readable medium, such as a portable memory drive or optical disk.

### BRIEF DESCRIPTION OF THE DRAWINGS

The present invention is illustrated by way of example and not limited in the accompanying figures in which like reference numerals indicate similar elements and in which:

FIG. 1 shows a typical prior art workstation and communication connections.

FIG. 2 illustrates a system for assigning work to account collectors and monitoring and tracking work performed by account collectors, in accordance with an embodiment of the invention.

FIG. 3 illustrates a graphical user interface that may be used to import collections data, in accordance with an embodiment of the invention.

FIG. 4 illustrates a graphical user interface that may be used by a team leader or other entity to redistribute accounts among account collectors, in accordance with an embodiment of the invention.

FIG. 5 illustrates a graphical user interface that may be used by a team leader or other entity to redistribute accounts among account collectors based on aged debt, in accordance with an embodiment of the invention.

FIG. 6 illustrates an account collector's action user interface, in accordance with an embodiment of the invention.

FIG. 7 illustrates a page of next actions for an account collector grouped by account code, in accordance with an embodiment of the invention.

FIG. 8 illustrates an exemplary graphical user interface that shows invoice details, in accordance with an embodiment of the invention.

FIG. 9 illustrates a graphical user interface that may be used to generate reports, in accordance with an embodiment of the invention.

FIG. 10 illustrates an exemplary graphical user interface that includes a mechanism for a team leader or other entity to add comments that will be viewable by collectors, in accordance with an embodiment of the invention.

FIG. 11 illustrates an exemplary report that may be generated, in accordance with an embodiment of the invention.

### DETAILED DESCRIPTION

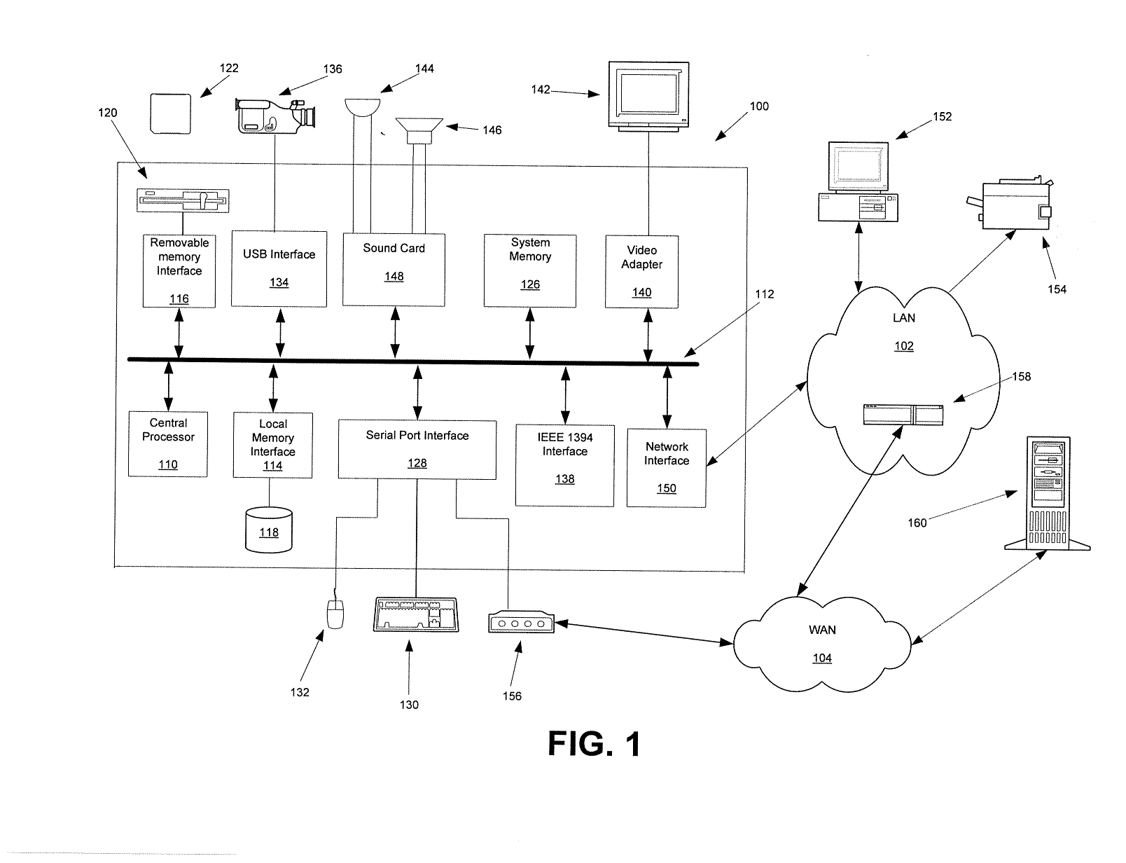

Various embodiments of the present invention may be implemented with computer devices and systems that exchange and process data. Elements of an exemplary computer system are illustrated in FIG. 1, in which the computer 100 is connected to a local area network (LAN) 102 and a wide area network (WAN) 104. Computer 100 includes a central processor 110 that controls the overall operation of the computer and a system bus 112 that connects central processor 110 to the components described below. System bus 112 may be implemented with any one of a variety of conventional bus architectures.

Computer 100 can include a variety of interface units and drives for reading and writing data or files. In particular, computer 100 includes a local memory interface 114 and a removable memory interface 116 respectively coupling a hard disk drive 118 and a removable memory drive 120 to system bus 112. Examples of removable memory drives include magnetic disk drives and optical disk drives. Hard disks generally include one or more read/write heads that convert bits to magnetic pulses when writing to a computer-readable medium and magnetic pulses to bits when reading data from the computer readable medium. A single hard disk drive 118 and a single removable memory drive 120 are shown for illustration purposes only and with the understanding that computer 100 may include several of such drives. Furthermore, computer 100 may include drives for interfacing with other types of computer readable media such as magneto-optical drives.

Unlike hard disks, system memories, such as system memory 126, generally read and write data electronically and do not include read/write heads. System memory 126 may be implemented with a conventional system memory having a read only memory section that stores a basic input/output system (BIOS) and a random access memory (RAM) that stores other data and files.

A user can interact with computer 100 with a variety of input devices. FIG. 1 shows a serial port interface 128 coupling a keyboard 130 and a pointing device 132 to system bus 112. Pointing device 132 may be implemented with a hard-wired or wireless mouse, track ball, pen device, or similar device.

Computer 100 may include additional interfaces for connecting peripheral devices to system bus 112. FIG. 1 shows a universal serial bus (USB) interface 134 coupling a video or digital camera 136 to system bus 112. An IEEE 1394 interface 138 may be used to couple additional devices to computer 100. Furthermore, interface 138 may be configured to operate with particular manufacture interfaces such as FireWire developed by Apple Computer and i.Link developed by Sony. Peripheral devices may include touch sensitive screens, game pads scanners, printers, and other input and output devices and may be coupled to system bus 112 through parallel ports, game ports, PCI boards or any other interface used to couple peripheral devices to a computer.

Computer 100 also includes a video adapter 140 coupling a display device 142 to system bus 112. Display device 142 may include a cathode ray tube (CRT), liquid crystal display (LCD), field emission display (FED), plasma display or any other device that produces an image that is viewable by the user. Sound can be recorded and reproduced with a microphone 144 and a speaker 146. A sound card 148 may be used to couple microphone 144 and speaker 146 to system bus 112.

One skilled in the art will appreciate that the device connections shown in FIG. 1 are for illustration purposes only and that several of the peripheral devices could be coupled to system bus 112 via alternative interfaces. For example, video camera 136 could be connected to IEEE 1394 interface 138 and pointing device 132 could be connected to USB interface 134.

Computer 100 includes a network interface 150 that couples system bus 112 to LAN 102. LAN 102 may have one or more of the well-known LAN topologies and may use a variety of different protocols, such as Ethernet. Computer 100 may communicate with other computers and devices connected to LAN 102, such as computer 152 and printer 154. Computers and other devices may be connected to LAN 102 via twisted pair wires, coaxial cable, fiber optics or other media. Alternatively, radio waves may be used to connect one or more computers or devices to LAN 102.

A wide area network 104, such as the Internet, can also be accessed by computer 100. FIG. 1 shows a modem unit 156 connected to serial port interface 128 and to WAN 104. Modem unit 156 may be located within or external to computer 100 and may be any type of conventional modem, such as a cable modem or a satellite modem. LAN 102 may also be used to connect to WAN 104. FIG. 1 shows a router 158 that may connect LAN 102 to WAN 104 in a conventional manner. A server 160 is shown connected to WAN 104. Of course, numerous additional servers, computers, handheld devices, personal digital assistants, telephones and other devices may also be connected to WAN 104.

The operation of computer 100 and server 160 can be controlled by computer-executable instructions stored on a computer-readable medium 122. For example, computer 100 may include computer-executable instructions for transmitting information to server 160, receiving information from server 160 and displaying the received information on display device 142. Furthermore, server 160 may include computer-executable instructions for transmitting hypertext markup language (HTML) and extensible markup language (XML) computer code to computer 100.

As noted above, the term “network” as used herein and depicted in the drawings should be broadly interpreted to include not only systems in which remote storage devices are coupled together via one or more communication paths, but also stand-alone devices that may be coupled, from time to time, to such systems that have storage capability. Consequently, the term “network” includes not only a “physical network” 102, 104, but also a “content network,” which is comprised of the data—attributable to a single entity—which resides across all physical networks.

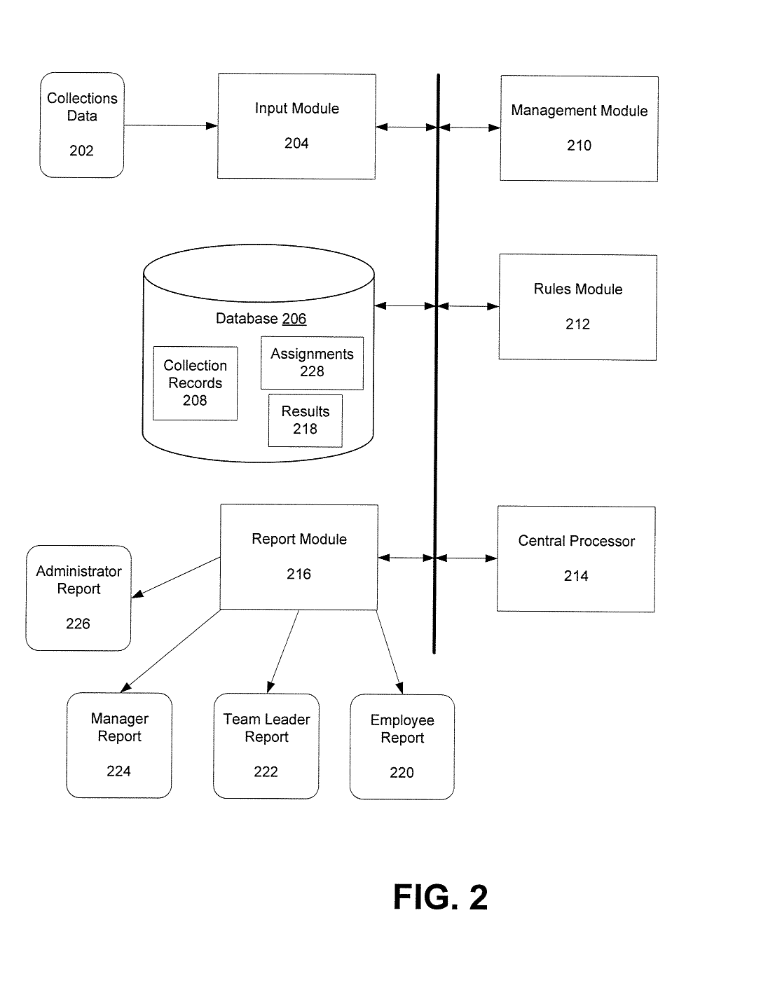

FIG. 2 illustrates a system for assigning work to account collectors and monitoring and tracking work performed by account collectors, in accordance with an embodiment of the invention. Collections data module 202 may be configured to communicate collections data in the form of a spreadsheet, XML document, text document or any other file or files that contain account information to an input module 204, which in turn may be configured to retrieve collection data from the file and place the data into a database 206. Collection data may be stored as collection records 208 within database 206. In one embodiment input module 204 is configured to parse a spreadsheet or XML file to retrieve collections data.

A management module 210 may be included to allow a team leader or other person to assign accounts to account collectors. In one embodiment, management module 210 generates one or more graphical user interfaces that allow a team leader to set account assignment rules. An exemplary graphical user interface is shown in FIG. 4 and is described below. The rules determine how accounts will be assigned to account collectors. The rules may also be used to set priorities. For example, a set of rules may be configured to analyze accounts that fall within a 90 days overdue bucket and prioritize accounts that have balances that total 60% of the total balance for the bucket. Similarly, the set of rules may be configured to analyze accounts that fall within 60, 30 and 0 days overdue buckets and prioritize accounts that have balances that total 80% of the total balance for the bucket. A rules module 212 may be implemented with a rules engine that processes collection data in accordance with rules set by a team leader to assign accounts to account collectors and prioritize accounts. Database 206 may include account assignments 228.

A central processor 214 may be included to control the system shown in FIG. 2. Central processor may be implemented with a conventional microprocessor or control logic. At least some of the modules shown in FIG. 2 may be implemented with computer-executable instructions that are executed by central processor 214.

A reports module 216 may be included to track results and generate reports. Database 206 may store results 218. Reports module 216 may generate employee reports 220, team leader reports 222, manager reports 224, administrator reports 226 or any other type of report that shows information such as results, status or performance of the collection process. Exemplary reports are described below. Although not explicitly shown in FIG. 2, the report(s) thus generated by the reports module may be communicated to one or more category of user i.e. employee, team leader, manager, administrator etc., via user terminal(s). The user terminal may include any device suitable for presenting data and in accepting input from the user. By way of example, the user terminal can be selected from the group comprising of personal computer, laptop computer, mainframe computer, dumb terminal, data display, Internet browser, Personal Digital Assistant (PDA), two-way pager, wireless terminal, portable telephone, or any other form of networked personal computing device.

One skilled in the art will appreciate that the system shown in FIG. 2 may be implemented with a variety of software and hardware components. By way of example, one or more modules of the system illustrated in FIG. 2 may be implemented using, but not limiting to, programmable logic arrays, application specific integrated circuits (ASICS) or other techniques known to those of skill in the art. Moreover, the functions performed by the modules shown may be combined into fewer modules or distributed across additional modules. Database 206 may be implemented with a conventional database that includes an index or any other collection of data that is arranged for retrieval by a computer device. Also, one or more modules of the system may be located at one or more different locations, such as different machines which may communicate with each other using any of the conventional technique. By way of example, the collections data module may reside on a different machine.

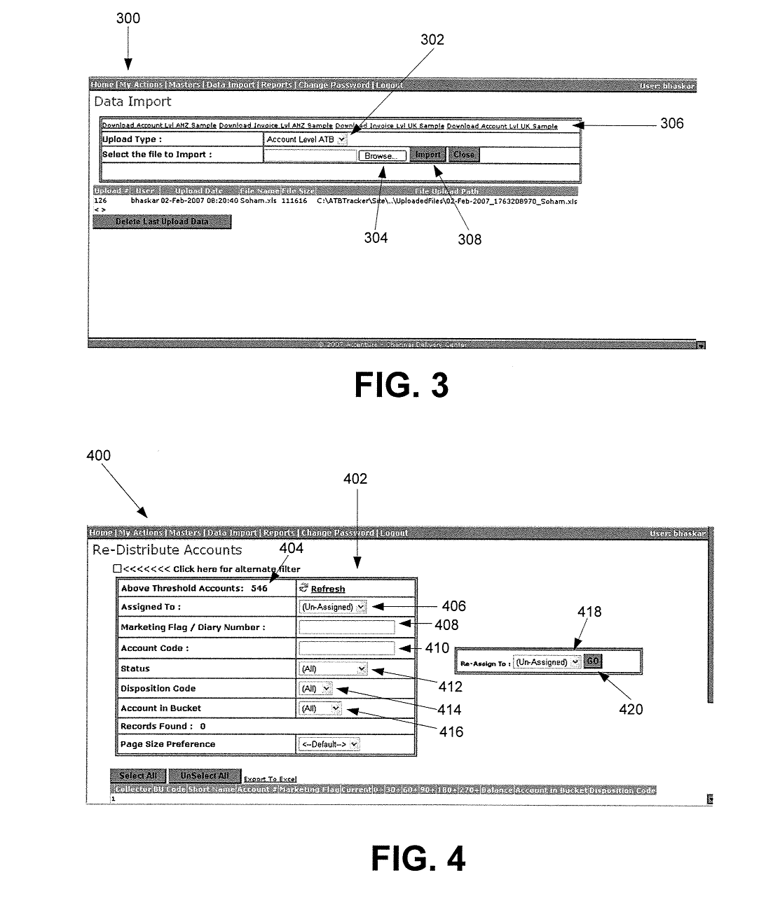

FIG. 3 illustrates a graphical user interface 300 that may be used to import collections data, in accordance with an embodiment of the invention. The collections data may be in the form of a spreadsheet that lists accounts and account details. A user may identify the upload type by making an appropriate selection in drop down menu 302. The type may identify the format of the document being uploaded. A browse icon 304 may be selected to search files stored on a computer, network or external device. In various embodiments collection data may be geographic specific. The format of a document from one geographic region may be different from the format of similar documents from other geographic regions. A row of geographic identifiers 306 may be included to identify the geographic region of the collections data that will be imported. Alternative, geographic identifiers may be included in drop down menu 302. After all of the selections are made, an import icon 308 may be selected to import the collections data. When the collections data is in spreadsheet, for example, the software application may use the information provided in graphical user interface 300 to parse the entries in the spreadsheet and add collections records to a database, such as database 206.

FIG. 4 illustrates a graphical user interface 400 that may be used by a team leader or other entity to redistribute accounts among account collectors, in accordance with an embodiment of the invention. Graphical user interface 400 may be generated by management module 210 (shown in FIG. 2). A total number of accounts meeting criteria identified in column 402 is displayed in region 404. Column 402 may include drop down menus, buttons, text regions or any other conventional input tools to identify a subset of accounts. A drop down menu 406 allows a user to select accounts based on current assignments or lack of an assignment. Marketing flag, diary number and account code information may be provided in input fields 408 and 410. Status information may be provided with drop down menu 412. Status may include closed, work in progress, internal issues or any other identifier that is used to identify the status of an account. Disposition code information may be provided with drop down menu 414. Disposition codes may include broken promise, call back, do not chase, disputed debt, legal, left voice message, no contact available, paid, pre-legal or any other code used to identify the disposition of an account. Drop down menu 416 may be used to identify buckets of accounts, such as accounts that are current, 30 days overdue, 60 days overdue, 90 days overdue, 180 days overdue and 270 days overdue. A drop down menu 418 may be used to identify account collectors to whom the accounts will be assigned. A go icon 420 is used to complete redistribute the accounts among account collectors.

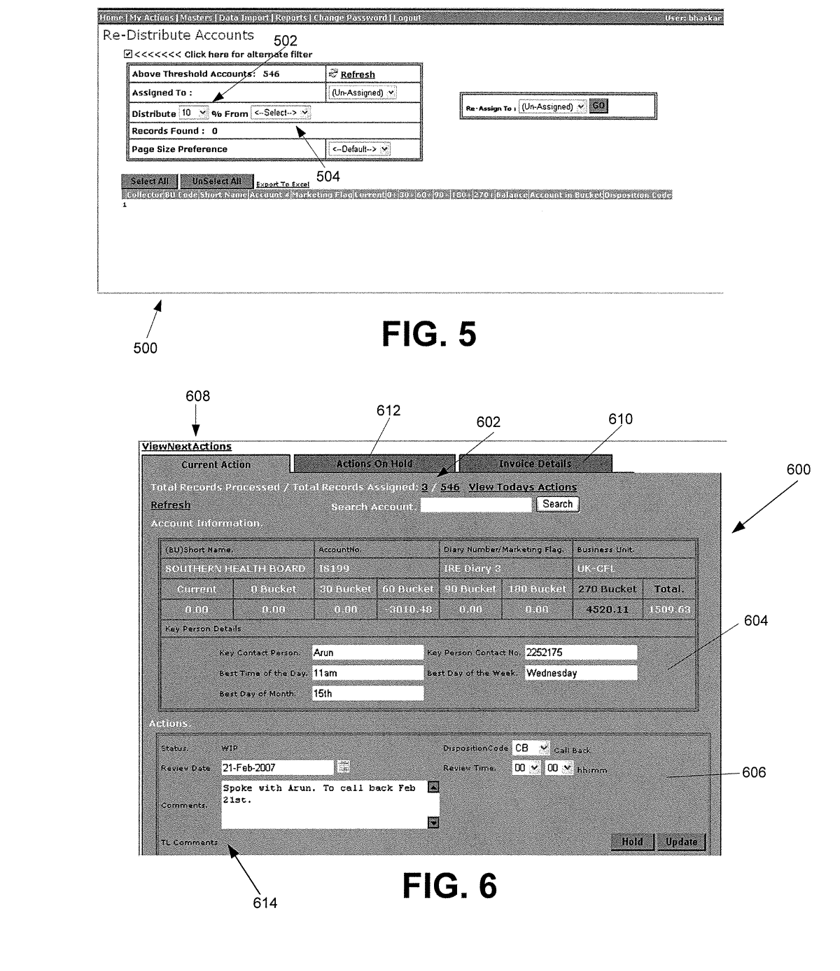

FIG. 5 illustrates an alternative graphical user interface 500 that may be used by a team leader or other entity to redistribute accounts among account collectors based on aged debt, in accordance with an embodiment of the invention. A drop down menu 502 may be used to identify a percentage of accounts and a drop down menu 504 may be used to identify an aged account bucket, such as current, 30 days overdue, 60 days overdue, 90 days overdue, 180 days overdue and 270 days overdue. In another embodiment a user interface element may be included to allow a user to select a quantity of accounts instead of a percentage of accounts.

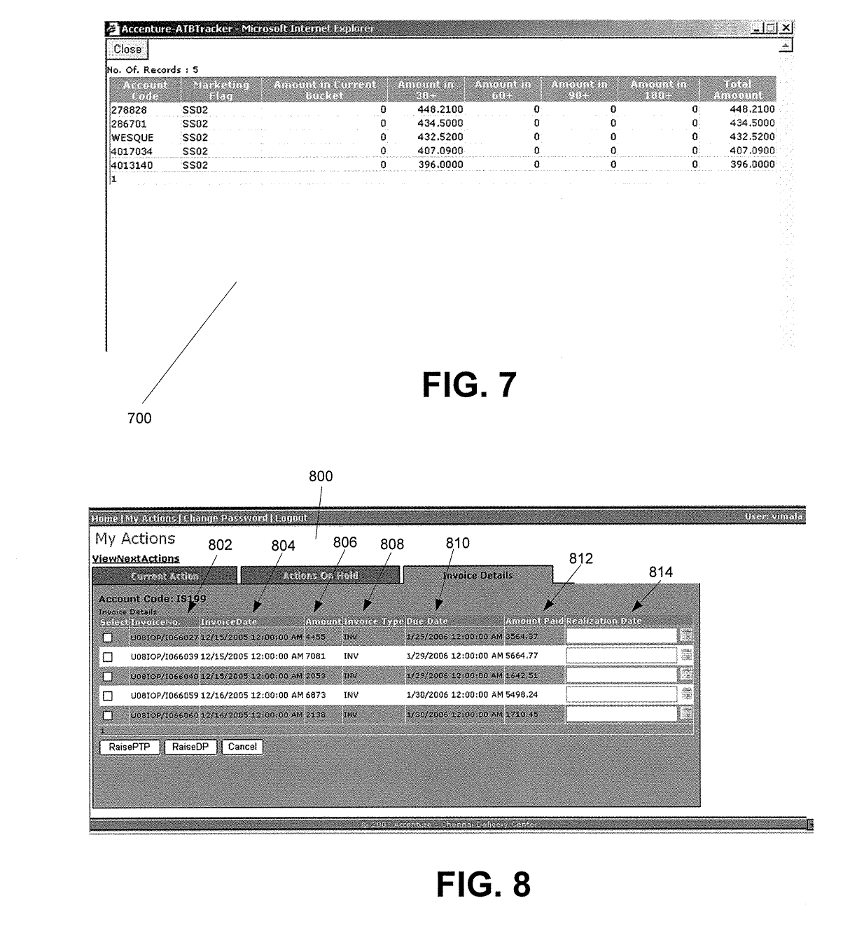

FIG. 6 illustrates an account collector's action user interface 600, in accordance with an embodiment of the invention. A status region 602 displays a number of accounts that have been processed and a total number of accounts. In the example shown the account collector has processed 3 accounts out of a total of 546 accounts. This data may be updated in real time. Account information is shown in region 604 and action information is shown in region 606. Action information may include the review date, comments, disposition code and review time. Of course additional or alternative information may be included to indicate what action was taken by the account collector. A view next actions hyperlink 608 may be linked to a page that shows a list of actions, such as page 700 shown in FIG. 7.

An invoice details tab 610 may be selected to display a graphical user interface that shows invoice details. FIG. 8 illustrates an exemplary graphical user interface 800 that shows invoice details, in accordance with an embodiment of the invention. One skilled in the art will appreciate that a variety of invoice details may be displayed, such as invoice number 802, invoice date 804, amount of the invoice 806, invoice type 808, due date 810 and amount paid 812 and realization date 814. Realization date 814 is a date on which a customer promises to make a payment.

Returning to FIG. 6, an actions on hold tab 612 may be selected to access a list of actions on hold. An action may be placed on hold, for example, if a customer requests that the account collector call the customer gain in 10 minutes. In one embodiment of the invention, an account collector must act on all of the actions listed in the actions on hold list before logging off of the system for the day. In another embodiment of the invention, any actions listed in the actions on hold list at the end of a shift are identified as the highest priority actions at the beginning of the account collector's next shift.

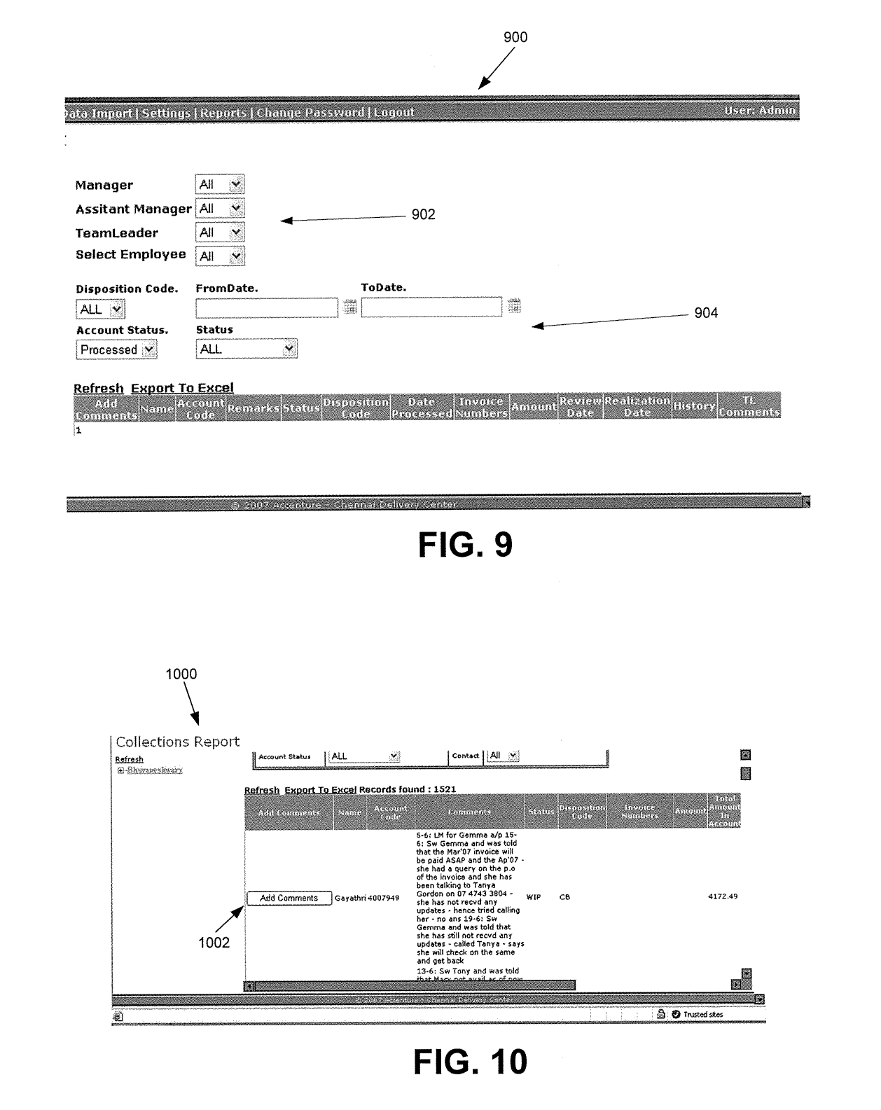

FIG. 9 illustrates a graphical user interface 900 that may be used to generate reports, in accordance with an embodiment of the invention. Section 902 allows for the selection of managers, assistant mangers, team leaders and employees. In some embodiments section 902 is a function of the rights belonging to a logged in user. For example, if an assistant manger is logged into the system, the assistant manger will see drop down menus for team leaders and employee. Section 904 allows for the selection of report criteria. Of course, additional or fewer selection criteria may be included to generate reports based on any of the information included in database 206 (shown in FIG. 2).

FIG. 10 illustrates an exemplary graphical user interface that includes a mechanism for a team leader or other entity to add comments that will be viewable by collectors. An add comments icon 1002 may be selected to allow for the insertion of comments. Team leaders and others may add comments when reviewing the processed accounts. This option enables the team leaders to guide and coach collectors by inputting their comments in the provided field where by the account collectors will be able to read the comments from their home page or another page. FIG. 6, for example, includes a field 614 that may be used to show team leader comments. The addition of comments helps account collectors adopt the proper or preferred strategies.

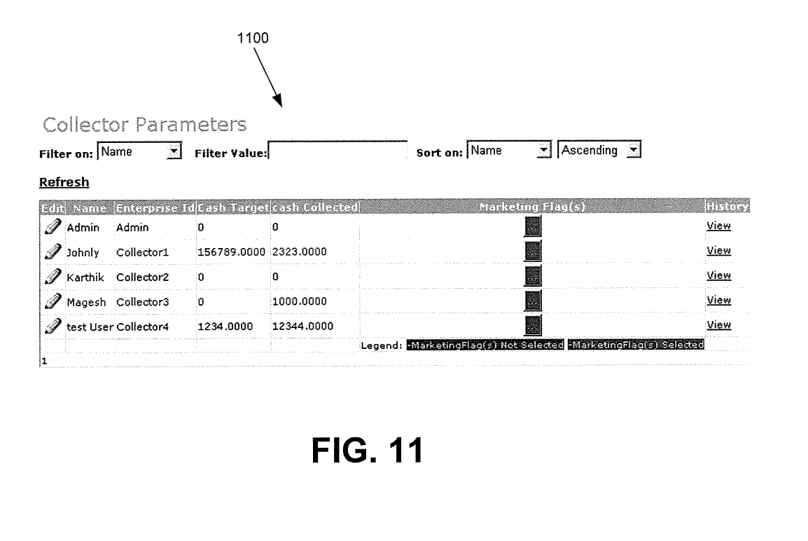

FIG. 11 illustrates an exemplary report 1100 that may be generated by report module 216 (shown in FIG. 2). Report 1100 includes values for cash targets and cash collected for a group of account collectors. Reports help team leaders and others set the collector parameters that may include predefined diary/market flag, cash target for the month and month to date cash collected information.

The present invention has been described herein with reference to specific exemplary embodiments thereof. It will be apparent to those skilled in the art that a person understanding this invention may conceive of changes or other embodiments or variations, which utilize the principles of this invention without departing from the broader spirit and scope of the invention as set forth in the appended claims. All are considered within the sphere, spirit, and scope of the invention.

We claim:

1. A computer-implemented method of assigning accounts to account collectors, the method comprising:
(a) receiving a collection of accounts at an input module;
(b) accessing a set of rules established by a team leader; and
(c) executing an application that assigns accounts to account collectors in accordance with the set of rules.

2. The computer-implemented method of claim 1, wherein the collection of accounts includes data characterizing the accounts and that corresponds to at least some criteria included in the set of rules.

3. The computer-implemented method of claim 2, wherein the information characterizing the account indicates the age of the account.

4. The computer-implemented method of claim 2, wherein the information characterizing the account indicates the balance of the account.

5. The computer-implemented method of claim 1, further including:
(d) receiving an input from a team leader to reassign at least one account; and
(e) in response to (d) reassigning the at least one account.

6. The method of claim 1, wherein the set of rules includes at least one rule that prioritizes accounts assigned to account collectors.

7. The computer-implemented method of claim 6, further including:
(d) receiving an input from a team leader to modify the at least one rule that prioritizes accounts assigned to account collectors; and
(e) in response to (d), reprioritizing accounts assigned to account collectors in accordance with the input from the team leader.

8. The computer-implemented method of claim 7, wherein (e) comprises redistributing accounts to account collectors.

9. The computer-implemented method of claim 1, further including:
(d) receiving status data from account collectors; and
(e) generating a real time status report.

10. The computer-implemented method of claim 9, wherein the status report indicates the status of accounts assigned to a single account collector.

11. The computer-implemented method of claim 9, wherein the status report comprises an aggregate report that indicates the status of accounts assigned to account collectors who report to a team leader.

12. The computer-implemented method of claim 9, wherein the status report indicates a number of accounts contacted by an account collector.

13. The computer-implemented method of claim 9, wherein the status report indicates an amount collected by an account collector.

14. The computer-implemented method of claim 1, further including:
(d) receiving status data from account collectors; and
(e) in response to (d) generating call reminder dates.

15. A web-based system that assigns accounts to account collectors, the system comprising:
(a) an input module configured to receive an electronic file and extract account information;
(b) a rules modules configured to receive input and establish a set of rules for assigning accounts to account collectors; and
(c) a processor configured to process the set of rules and the account information to assign accounts to account collectors.

16. The web-based system of claim 15, further including a database containing account information and coupled to the processor.

17. The web-based system of claim 16, further including a report module configured to retrieve data from the database and generate reports.

18. The web-based system of claim 17, wherein the reports are generated in real time.

19. The web-based system of claim 15, further including a collections data module configured to communicate the collections data in the form of an electronic file to the input module.

20. The web-based system of claim 15, further comprising at least one user terminal in communication with the reports module for communicating the same to at least one user.

21. A tangible computer-readable medium containing computer-executable instructions for performing the steps comprising:
(a) receiving a collection of accounts at an input module;
(b) accessing a set of rules established by a team leader; and
(c) executing an application that assigns accounts to account collectors in accordance with the set of rules.

22. The tangible computer-readable medium of claim 21, containing further computer-executable instructions for performing the steps comprising:
(d) receiving an input from a team leader to modify the at least one rule that prioritizes accounts assigned to account collectors; and
(e) in response to (d), reprioritizing accounts assigned to account collectors in accordance with the input from the team leader.
